(19) United States
(12) Patent Application Publication
(10) Pub. No.: US 2011/0292424 A1
(43) Pub. Date: Dec. 1, 2011

(54) Computer Readable Medium Having Common Printer Driver, and Print Port Managing Method

(75) Inventor: Mareyuki MURATA, Nagoya-shi (JP)

(73) Assignee: BROTHER KOGYO KABUSHIKI KAISHA, Nagoya-shi (JP)

(21) Appl. No.: 13/044,625

(22) Filed: Mar. 10, 2011

(30) Foreign Application Priority Data
May 26, 2010 (JP) 2010-120755

(51) Int. Cl. G06F 15/00

(52) U.S. Cl. 358/1.13; 358/1.15

(57) ABSTRACT

A non-transitory computer readable medium having a common printer driver to be executed by a print control device communicatively connected to one or more printers and mounting an operating system is provided. The common printer driver, when executed by the print control device, causing the print control device to perform the steps of: selecting any printer from one or more of the printers; generation requesting the operating system to generate a logical print port for communication with a printer selected in the selecting step, recording usage history of the print port generated in the generation requesting step, and deletion requesting for determining whether the print port is necessary or not based on the usage history and requesting the operating system to delete the print port determined to be unnecessary.

### CROSS REFERENCE TO RELATED APPLICATION

The present application claims priority from Japanese Patent Application No. 2010-120755 filed on May 26, 2010. The entire content of this priority application is incorporated herein by reference.

The present invention relates to a non-transitory computer readable medium having a common printer driver and a print port managing method.

### BACKGROUND

Conventionally, a printing system has been well-known that generates a port for sending print data to a printer selected by an user and, after sending print data to the printer by using information of the generated port, deletes the generated port.

### SUMMARY

However, according to such a conventional printing system, the port is deleted every time after the print data was sent, and generation of a port is therefore necessary in every printing. Thus, the waiting time for a print start tends to be long.

The present invention has been made on the basis of the above circumstances, and its object is to provide a computer readable medium having a common printer driver and a print port managing method capable of avoiding an extended waiting time for a print start, while at the same time deleting an unnecessary port.

An aspect of the present invention provides a non-transitory computer readable medium having a common printer driver to be executed by a print control device communicatively connected to one or more printers and mounting an operating system. The common printer driver, when executed by the print control device, causing the print control device to perform the steps of: selecting any printer from one or more of the printers; generation requesting the operating system to generate a logical print port for communication with a printer selected in the selecting step, recording usage history of the print port generated in the generation requesting step, and deletion requesting for determining whether the print port is necessary or not based on the usage history and requesting the operating system to delete the print port determined to be unnecessary.

An aspect of the present invention provides a print port managing method for a print port in a print control device communicatively connected to one or more printers. The method comprises the steps of: selecting any printer from the one or more printers; generating a logical print port for communication with a printer selected in the selecting step; recording usage history of the print port generated in the generating step, and deleting for determining whether the print port is necessary or not based on the usage history and deleting the print port determined as an unnecessary port.

### BRIEF DESCRIPTION OF THE DRAWINGS

FIG. 1 is a block diagram showing an electrical configuration of a computer according to Illustrative aspect 1 in the present invention;

FIG. 2 is a pattern diagram explaining generation of a print port;

FIG. 3 is a block diagram showing a logical configuration of a common printer driver;

FIG. 4 is a pattern diagram showing an example of various windows displayed when printing;

FIG. 5 is a flowchart showing a printing processing flow.

### DETAILED DESCRIPTION

<Illustrative Aspect>

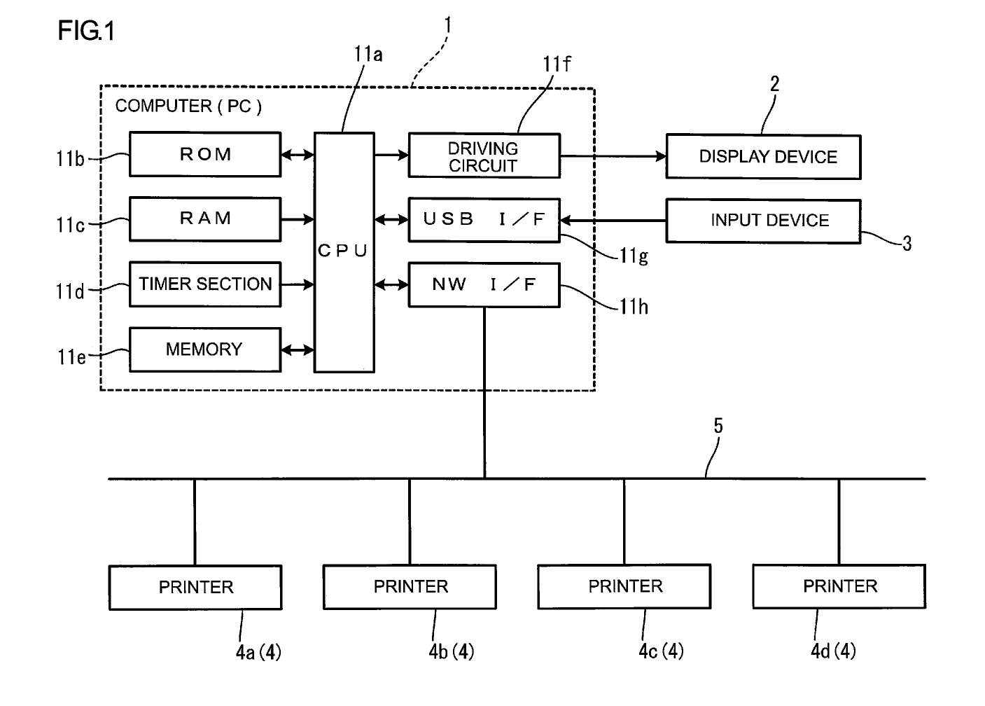

Illustrative aspect of the present invention is explained in reference to FIGS. 1 to 5.

### (1) Configuration of Computer

FIG. 1 is a block diagram showing an electrical configuration of a computer (an example of a print control device) according to Illustrative aspect 1 in the present invention. A computer 1 (hereinafter, referred to as “PC”) includes a CPU 11a, a ROM 11b, a RAM 11c, a timer section 11d, a memory 11e, a display driving circuit 11f, an USB interface 11g (USB I/F), and a network interface 11h (NW I/F).

The CPU 11a controls each part of the PC 1 by executing various programs stored in the ROM 11b and the memory 11e. The ROM 11b stores various programs and data to be executed by the CPU 11a. The RAM 11c is used as a main storage device for the CPU 11a for execution of various processing (step).

The timer section 11d includes a timer for acquiring a current time. The memory 11e is an external storage device for storing various programs and data with a nonvolatile storage medium, such as a hard disk and a flash memory. Stored in the memory 11e are an operating system (OS), application programs for word processor and table calculation (hereinafter referred to as “applications”), a common printer driver, an usage history file, a port registration file. The present illustrative aspect is explained using Windows (registered mark) of Microsoft Corporation, as an example of the OS. The OS is not limited to Windows.

The display driving circuit 11f drives a display device 2 (a CRT, a liquid crystal display, and the like), and is connected thereto via a cable. The USB interface 11g is constituted, for example, as an USB (Universal Serial Bus) host interface and connected to devices such as an input device 3 (a mouse, a keyboard, and the like) via an USB cable. The network interface 11h is communicatively connected to one or more printers 4 via a communication network 5, such as a LAN and the internet.

The printer 4 (4a to 4d) is a device for forming images on a recording medium, such as paper, in the electrophotographic system or the ink-jet system. A plurality of printers 4 may be of different manufacturers, or of the same manufacturer but different models. In what follows, the printer 4 means any one of the printers 4a to 4d.

### (2) Generation/Deletion of Print Port

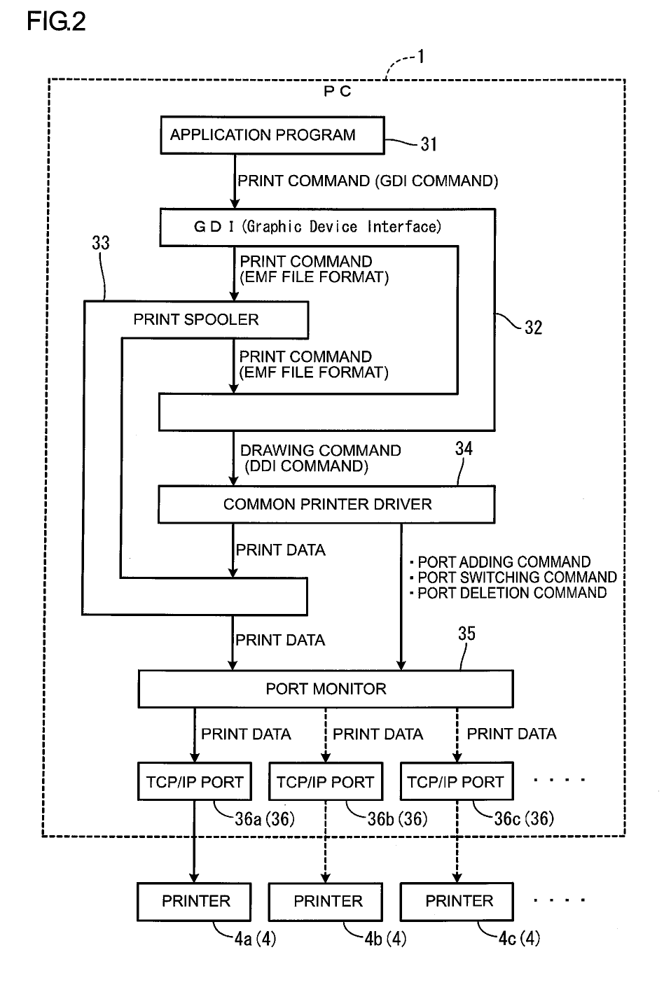

FIG. 2 is a pattern diagram explaining generation/deletion of a print port. Here, a TCP/IP port is used as an example of a print port. The TCP/IP port is a logical communication port for communicating with the printer 4 via the communication network 5. Additionally, the TCP/IP port is referred to as a standard TCP/IP port in Windows.

Generation of a TCP/IP port 36 is conducted through a port monitor 35. The port monitor 35 is a program supplied as a part of Windows. When received a port adding command from the common printer driver 34, and when the TCP/IP port 36 having a port name designated by the port adding command set therein is present, the port monitor 35 adds (generates) the TCP/IP port 36 by using the port name and an IP address (location information showing a location on the communication network 5) designated by the port adding command.

A plurality of TCP/IP ports 36 can exist as long as they have different port names. When received a port switching command from the common printer driver 34, the port monitor 35 enables the TCP/IP port 36 having the port name designated by the port switching command set therein. Additionally, when received a port deleting command from the common printer driver 34, the port monitor 35 deletes the TCP/IP port 36 having the port name designated by the port deleting command set therein.

### (3) Logical Configuration of Common Printer Driver

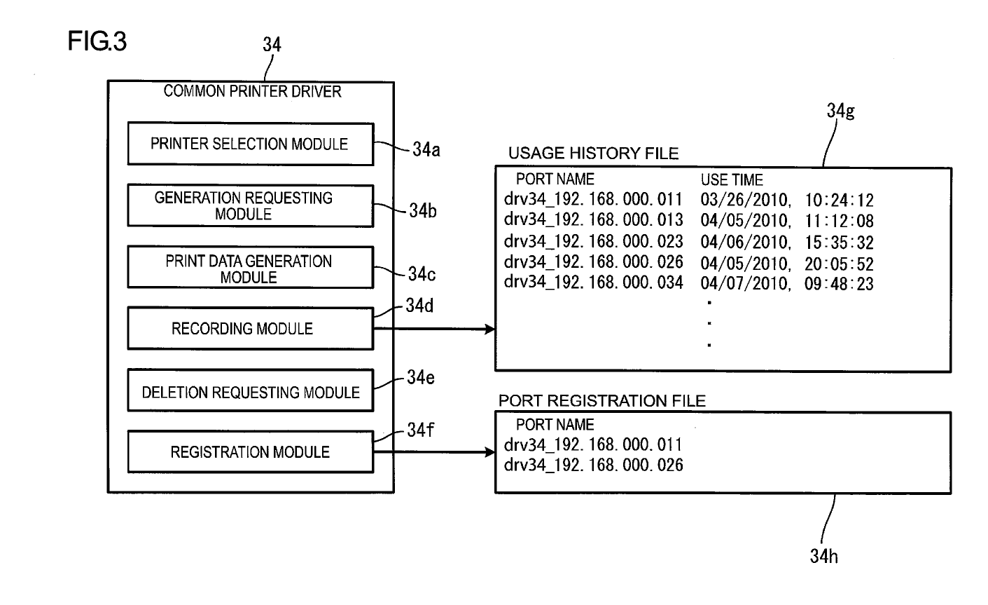

FIG. 3 is a block diagram showing a logical configuration of the common printer driver 34. FIG. 3 also shows an usage history file 34g and a port registration file 34h used by the common printer driver 34.

The common printer driver 34 can be used commonly among a plurality of printers 4 of different models. The common printer driver 34 includes a printer selection module 34a, a generation requesting module 34b, a print data generation module 34c, a recording module 34d, a deletion requesting module 34e, a registration module 34f. The common printer driver 34 is stored in a computer readable medium, for example a CD-ROM or a hard disk.

The printer selection module 34a allows an user to select one printer 4 from a plurality of printers 4 connected to the communication network 5.

The generation requesting module 34b requests the port monitor 35 to generate the TCP/IP port 36 for communicating with the selected printer 4. In particular, the generation requesting module 34b designates an IP address of the selected printer 4 and a port name to be generated, so as to output a port adding command to the port monitor 35, while on the other hand, designates the port name and outputs a port switching command to the port monitor 35.

The same port name is generated as long as the IP address is the same. In other words, in the common printer driver 34, a plurality of TCP/IP ports 36 of different names are not generated for one printer 4, as long as the IP address is the same. In addition, a port name includes a string of letters (for example, “drv34”) unique to the common printer driver 34, so as to identify the TCP/IP port 36 generated by the common printer driver 34 from other TCP/IP ports 36.

The identifying method for the TCP/IP port 36 generated from the common printer driver 34 is not limited to the above. For example, port names of the TCP/IP ports 36 generated from the common printer driver 34 may be stored in a file, so that the TCP/IP port 36 generated from the common printer driver 34 can be identified as the one with its port name stored in the file.

The print data generation module 34c generates print data based on a print command output from the application 31 and a print condition set by an user, and outputs the generated print data to a print spooler 33.

When printing is conducted, the recording module 34c acquires a current time (year, month, day, time, minute, and second) from the timer section 11d, and while at the same time obtaining a port name of the TCP/IP port 36 to be used in the currently selected printer 4 (the port name of the TCP/IP port 36 having the IP address of the currently selected printer 4 set therein, in other words, the port name of the TCP/IP port 36 generated from the common printer driver 34) from the OS. The recording module 34c also associates the obtained port name with the current time (use time) and records in the usage history file 34g.

The deletion requesting module 34e determines whether the TCP/IP port 36 is needed based on the usage history file 34g, and requests the port monitor 35 to delete the TCP/IP port 36 that has been determined as an unnecessary port. In particular, the deletion requesting module 34e designates the port name of the TCP/IP port 36 determined as an unnecessary port and outputs a port deleting command to the port monitor 35.

The registration module 34f registers the port name of the TCP/IP port 36 not to be deleted in the port registration file 34h.

The usage history file 34g is generated by the recording module 34d and records a port name of the TCP/IP port 36 to be used in the currently selected printer 4 and the latest use time of the printer 4. A port name and the TCP/IP port 36 are associated with each other one by one, and the usage history file 34 can therefore be referred to as a file recording the usage history of the TCP/IP port 36.

The port registration file 34h is generated by the registration module 34f and registers a port name of the TCP/IP port 36 not to be deleted.

### (4) Printing Flow

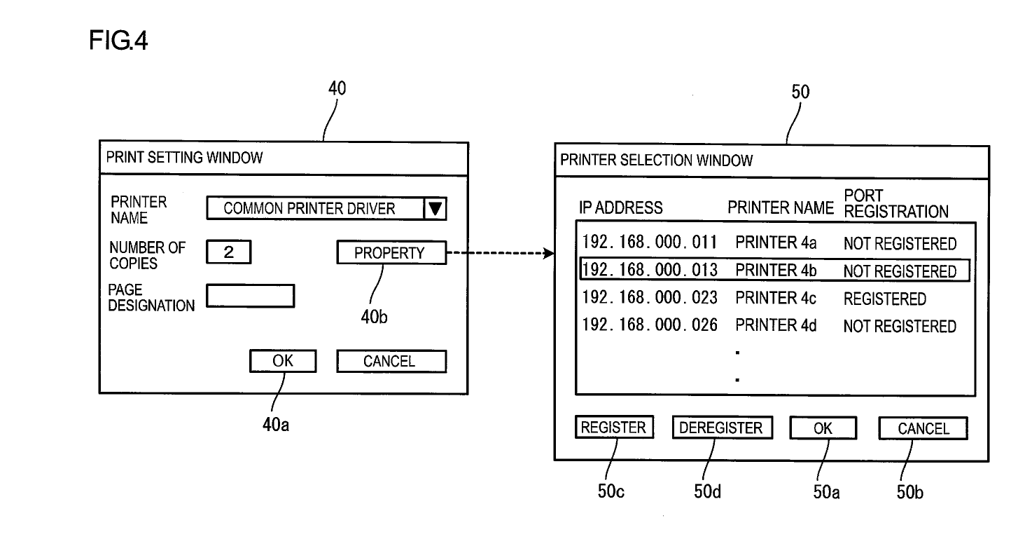

FIG. 4 is a pattern diagram showing an example of various windows displayed when printing. In what follows, the simple description “the common printer driver 34” means the CPU 11a executing the common printer driver 34. The same can be applied to the application 31.

When an user selects printing on a menu displayed by the application 31, the application 31 displays a print setting window 40 for selection of the printer 4 and setting of print conditions on the display device 2. With the user's click on an “OK” button 40a on the print setting window 40, the application 31 outputs a print command to the printer driver of the selected printer 4 via the OS.

Additionally, the print setting window 40 is provided with a “Property” button 40b. With the user's click on the “Property” button 40b, the application 31 calls up the printer driver of the selected printer 4. The common printer driver 34 does not respond to a particular printer 4. When calling up the common printer driver 34, it needs to be directly selected, instead of the printer 4. The following was made on the assumption that the common printer driver 34 has been selected.

When the user selected the common printer driver 34 and clicked the “Property” button 40b, the application 31 calls up the common printer driver 34. Then the common printer driver 34 firstly displays a printer selection window 50 on the display device 2.

Next, the common printer driver 34 searches the printer 4 ready for printing in the printers 4 connected to a subnet same as that is connected to the PC 1, and displays a list of IP addresses and printer names of the searched printers 4 on the printer selection window 50.

The common printer driver 34 then obtains a port name of the TCP/IP port 36 to be used in each printer 4 (the port name of the TCP/IP port 36 having the IP address of each printer 4 set therein, in other words, the port name of the TCP/IP port 36 generated from the common printer driver 34) from the OS. And the driver 34 displays “Not registered” or “Registered” on the printer selection window 50 in accordance with whether or not the obtained port name has been registered in the port registration file 34h. In this moment, “Not registered” is displayed for the printer 4 of the TCP/IP port 36 not generated.

Though not shown in FIG. 4, the print conditions for general print functions provided in the printer 4 (sheet size, color/monochrome, double-side printing, and the like) can also be set on the printer selection window 50.

The user can arbitrarily select the printer 4 from the printers 4 on the displayed list (selecting step). When the user clicked the “OK” button 50a with the printer 4 selected, the common printer driver 34 requests the port monitor 35 to generate the TCP/IP port 36 for communication with the selected printer 4 (generation requesting step), and then closes the printer selection window 50. With a click on a “Cancel” button 50b, the common printer driver 34 closes the printer selection window 50 without requesting the generation of the TCP/IP port 36.

Here, the user does not have to select the printer 4 each time. When printing with the printer 4 same as that of the prior printing, the printer selection window 50 is not needed to be displayed. The common printer driver 34 does not therefore request the generation of the TCP/IP port 36 in every printing.

In addition, the printer selection window 50 also allows the user to register a port name of the TCP/IP port 36 not to be deleted. When the user clicked a “Register” button 50c with any one printer 4 selected, the common printer driver 34 registers a port name of the TCP/IP port 36 to be used in the selected printer 4 in the port registration file 34h (registration step). As shown in the FIG. 4, the printer selection window 50 also displays a “Deregister” button 50d for deregistration. When the “Register” button 50c is clicked with the TCP/IP port 36 of the selected printer 4 not yet generated, an error message is displayed.

When the printer selection window 50 is closed, the control returns to the print setting window 40. With the user's click on the “OK” button 40a on the print setting window 40, the application 31 outputs a print command to the common printer driver 34 as mentioned above. With the output of the print command, the common printer driver 34 starts the printing processing as below.

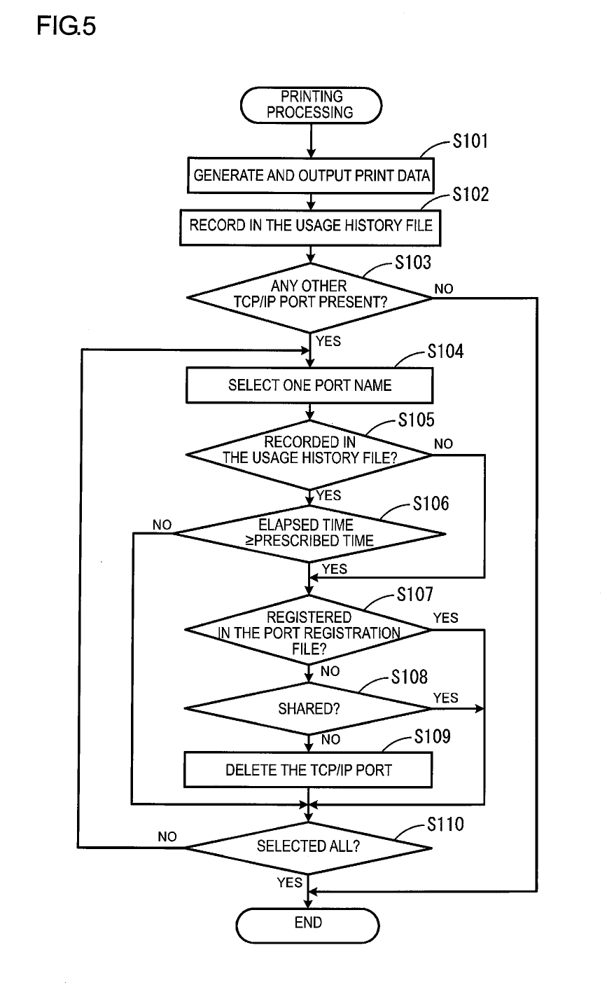

In S101 of FIG. 5, the common printer driver 34 generates print data based on the print command output from the application 31 and the print condition set by the user, and then outputs the generated print data to the print spooler 33.

As shown in FIG. 2, the print data output to the print spooler 33 is then output to the port monitor 35, and then to the currently available TCP/IP port 36 (the TCP/IP port 36 to be used in the currently selected printer 4) by the port monitor 35. The print data output to the TCP/IP port 36 is then sent to the printer 4, that is provided with the IP address set in the TCP/IP port 36, via the communication network 5.

In S102, the common printer driver 34 associates the port name of the TCP/IP port 36 to be used in the selected printer 4 with the current time, and records in the usage history file 34g (recording step). When the port name has already been recorded in the usage history file 34g, the use time associated with the port name is updated to the current time.

The following processing in S103 to S110 determines whether the TCP/IP port is necessary or not based on the usage history and requests the port monitor 35 to delete the TCP/IP port that was determined as an unnecessary port (deletion requesting step).

In S103, the common printer driver 34 firstly obtains a port name of the TCP/IP port 36 other than the TCP/IP port 36 to be used in the currently selected printer 4 among the TCP/IP ports 36 generated from the common printer driver 34 from the OS. In particular, for example, the Windows registers the port name set in each TCP/IP port 36 in the registry, and thus, the common printer driver 34 obtains these port names (only the one including the above-mentioned unique string of letters) from the registry. When the common printer driver 34 obtained two or more port names, it is understood that other TCP/IP port 36 is present, and the processing goes to S104. On the other hand, when the common printer driver 34 cannot obtain two or more port names, it is understood that no other TCP/IP port 36 is present, and the processing ends.

In S104, the common printer driver 34 selects one port name from the port names obtained in S103. When the processing in S104 is the second time or thereafter, the common printer driver 34 selects a port name that has not been selected from the port names obtained in S103.

In S105, the common printer driver 34 determines whether the port name selected in S104 has been recorded in the usage history file 34g or not. When the port name has been recorded in the usage history file 34g, the processing goes to S106, and otherwise, goes to S107.

In S106, the common printer driver 34 firstly acquires the use time associated with the port name selected in S104 from the usage history file 34g. Next, the common printer driver 34 determines whether the elapsed time from the acquired use time to the current time is longer than a prescribed time or not. When the elapsed time is equal to or longer than a prescribed time, the common printer driver 34 decides the TCP/IP port 36 is unnecessary, and the processing goes to S107. When the elapsed time is shorter than a prescribed time, the common printer driver 34 decides the TCP/IP port 36 is necessary, and the processing goes to S110.

In S107, the common printer driver 34 determines whether or not the port name selected in S104 has been registered in the port registration file 34h. When the port name has not been registered, the processing goes to S108. When the port name has been registered, the processing skips the later described S108 and S109, and goes to S110. When the port name has been registered, the processing skips S109, and thus, the TCP/IP port 36 having the port name selected in S104 set therein is not deleted even when being unnecessary.

In S108, the common printer driver 34 obtains information from the OS in order to determine whether or not the TCP/IP port 36 having the port name selected in S104 set therein is being shared with other printer driver. Based on the obtained information, the common printer driver 34 determines whether the TCP/IP port 36 is being shared with other printer driver or not. When the TCP/IP port 36 is not being shared, the processing goes to S109, and otherwise, the processing skips the later described S109 and goes to S110. When the TCP/IP port 36 is being shared, the processing skips S109, and thus, the TCP/IP port 36 having the port name selected in S104 set therein is not deleted even when being unnecessary.

In S109, the common printer driver 34 requests the port monitor 35 to delete the TCP/IP port 36 having the port name selected in S104 set therein.

In S110, the common printer driver 34 determines whether the selection of all port names obtained in S103 has been completed or not. When the selection has been completed, the printing processing is ended, and otherwise, returns to S104 to repeat.

### (5) Effect of Illustrative Aspect

According to the common printer driver 34 in the above-mentioned Illustrative aspect 1 of the present invention, the TCP/IP port 36 that was determined as an unnecessary port is deleted, while on the other hand, the necessary TCP/IP port 36 (in the present illustrative aspect, the currently selected TCP/IP port 36, and also, the TCP/IP port 36 that has not been used for less than a prescribed time since the last use recorded in the usage history file 34g) remains. Therefore, the TCP/IP port 36 determined as an unnecessary port is deleted, while at the same time an extended waiting time for a print start in printing can be avoided with a necessary print port.

Furthermore, the common printer driver 34 records the time when the TCP/IP port 36 was used in the usage history file 34g and determines the TCP/IP port 36 that has not been used for equal to or longer than a prescribed time since the last use as an unnecessary TCP/IP port 36. Therefore, the TCP/IP port 36 that has not been used for a prescribed time can be deleted as an unnecessary TCP/IP port 36.

Furthermore, when the TCP/IP port 36 determined as an unnecessary port by the common printer driver 34 is being shared with other printer driver, the common printer driver 34 does not request the deletion the TCP/IP port 36. The TCP/IP port 36 that is unnecessary for the common printer driver 34 may be necessary for other printer drivers. According to the common printer driver 34, careless deletion of the TCP/IP port 36 shared with other printer drivers can be avoided.

Furthermore, the common printer driver 34 does not request the deletion of the TCP/IP port 36 having the port name registered in the port registration file 34h, even when the TCP/IP port 36 was determined as an unnecessary port. Deletion of the TCP/IP port 36 determined as an unnecessary port may not be always required, when the determination was made on the basis of the usage history. For example, the case when the TCP/IP port 36 is not used temporarily, however, is known to be used in future. This case, when the TCP/IP port 36 of the printer 4 is deleted for the reason that it has not been used temporarily, the time for print start takes long when using the printer 4. According to the common printer driver 34, the TCP/IP port 36 not to be deleted is registered in the port registration file 34h, so that the TCP/IP port 36 cannot be deleted.

Furthermore, the common printer driver 34 is activated when executing the printing processing in S101 (an example of a prescribed processing). The deletion requesting processing is executed after the execution of the printing processing (more precisely, the printing processing and the recording processing). Therefore, an user does not need to activate the common printer driver 34 only to instruct the deletion of the TCP/IP port 36. This improves the user-friendliness.

<Other Illustrative Aspects>

The present invention is not limited to the illustrative aspects described in the above with reference to the accompanying figures, and, for example, the following can also be included in the technical scope of the present invention.

(1) In the above illustrative aspect, an example was introduced where the TCP/IP port 36 that has not been used for equal to or longer than a prescribed time since the last use is determined as an unnecessary port. However, the determination may be made based on, for example, the use frequency (use per unit of time). In particular, the time when the TCP/IP port 36 was used may be recorded, so that the TCP/IP port 36 having a port name, whose recorded number of use time between the printing execution and a prescribed time is greater than a prescribed number, set therein is determined as an unnecessary port.

(2) In the above illustrative aspect, after execution of printing processing (S101) and recording step (S102), the deletion requesting step of the TCP/IP port 36 is executed. However, the executing timing of the deletion requesting step may be selectable, like, for example, before selection of the printer 4, generation requesting of the TCP/IP port 36, and registration of the TCP/IP port 36, or thereafter. Or, the deletion requesting step may be executed at a plurality of timings, not before/after any one step (processing).

What is claimed is:

1. A non-transitory computer readable medium having a common printer driver to be executed by a print control device communicatively connected to one or more printers and mounting an operating system, the common printer driver, when executed by the print control device, causing the print control device to perform the steps of:
selecting any printer from one or more of the printers;
generation requesting the operating system to generate a logical print port for communication with a printer selected in the selecting step,
recording usage history of the print port generated in the generation requesting step, and
deletion requesting step for determining whether the print port is necessary or not based on the usage history and requesting the operating system to delete the print port determined to be unnecessary.

2. The non-transitory computer readable medium according to claim 1, wherein:
the print port is sharable with a plurality of printer drivers; and,
in the deletion requesting step, in case the print port determined as an unnecessary port is shared with another printer driver, a request for deleting the print port is not sent.

3. The non-transitory computer readable medium according to claim 1, further causing the print control device to perform the steps of:
registering a print port not to be deleted in a memory, wherein:
in the deletion requesting step, in case the print port determined as an unnecessary port is registered in the memory, a request for deleting the print port is not sent.

4. The non-transitory computer readable medium according to claim 1, wherein:
the common printer driver is activated upon executing a prescribed processing other than the deletion requesting step, and
the deletion requesting step is executed before and/or after the execution of the prescribed processing.

5. The non-transitory computer readable medium according to claim 1, wherein:
the recording processing includes recording time when the print port was used in the usage history, and
the deletion requesting step includes determining a print port not used for longer than a prescribed time since the last use as an unnecessary print port.

6. A print port managing method for a print port in a print control device communicatively connected to one or more printers, comprising the steps of:
selecting any printer from the one or more printers;
generating a logical print port for communication with a printer selected in the selecting step;
recording usage history of the print port generated in the generating step, and
deleting step for determining whether the print port is necessary or not based on the usage history and deleting the print port determined as an unnecessary port.

7. The print port managing method according to claim 6, wherein:
the print port is sharable with a plurality of printer drivers; and,
in the deleting step, in case the print port determined as an unnecessary port is shared with another printer driver, a request for deleting the print port is not sent.

8. The print port managing method according to claim 6, further comprising the step of:
registering a print port not to be deleted in a memory, wherein:
in the deleting step, in case the print port determined as an unnecessary port is registered in the memory, a request for deleting the print port is not sent.

9. The print port managing method according to claim 6, wherein:
the deleting step is executed before and/or after an execution of a prescribed processing other than the deleting step.

10. The print port managing method according to claim 6, wherein:
the recording step includes recording time when the print port was used in the usage history, and
the deleting step includes determining a print port not used for longer than a prescribed time since the last use as an unnecessary print port.
